(19) United States
(12) Patent Application Publication
(10) Pub. No.: US 2026/0349388 A1
(43) Pub. Date: Nov. 5, 2026

(54) TIMEPIECE COMPONENT INTENDED TO BE DRIVEN ONTO AN ARBOR

(71) Applicant: Rolex SA, Genève 26 (CH)

(72) Inventors: Blaise FRACHEBOUD, Plan-les-Ouates (CH); Olivier KARLEN, Blonay (CH)

(21) Appl. No.: 19/660,210

(22) Filed: Apr. 27, 2026

(30) Foreign Application Priority Data
Apr. 30, 2025 (EP) 25173709.4

(51) Int. Cl. G04B 13/02

(52) U.S. Cl. CPC G04B 13/022

(57) ABSTRACT

The invention relates to a timepiece component intended to be driven onto an arbor along a driving axis, comprising a body, a coupling interface, a flexible peripheral portion, arranged between the body and the coupling interface, N first connecting bridges, linking the flexible peripheral portion with the coupling interface, second connecting bridges, linking the flexible peripheral portion with the body. N is an integer greater than or equal to 2, characterized in that, in a plane normal to the driving axis, at least one of the N first connecting bridges is offset from at least one of the second connecting bridges by an angle comprised between (170/N)° and (190/N)°, for example an angle of (180/N)°, and having the driving axis as a vertex.

### CROSS-REFERENCE TO RELATED APPLICATIONS

The present application claims priority to European Application No. 25173709.4 filed with the European Patent Office on Apr. 30, 2025, which is incorporated herein by reference in its entirety for all purposes.

### TECHNICAL FIELD OF THE INVENTION

The present invention generally relates to a timepiece component intended to be driven onto an arbor. The present invention particularly relates to the timepiece components intended to be driven onto an arbor, and formed from, or including, a brittle material (such as silicon) and/or including a flexible structure intended to cooperate with said arbor.

### STATE OF THE ART

In the prior art of the timepiece components intended to be driven onto an arbor, and formed from, or including, a brittle material (such as silicon or an electrodeposited material) and/or including a flexible structure intended to cooperate with said arbor, documents WO2011116486A1 or EP2796940A2 or EP2755093A2 or EP3327514A2 or EP2112565A2 are known. However, the components described in these documents cannot be used in all situations, and particularly for applications requiring the transmission of a torque or the resistance to shocks without sliding relative to the arbor, or for applications requiring large geometric compensation to address geometric variations in the diameter of the arbor for example.

### DISCLOSURE OF THE INVENTION

One aim of the present invention is to overcome the drawbacks of the prior art mentioned above and particularly, firstly, to propose a timepiece component intended to be driven onto an arbor, and formed of, or comprising, a brittle material (such as silicon or an electrodeposited material) and/or comprising a flexible structure intended to cooperate with said arbor, and whose design allows it to be used in many applications, such as those requiring the transmission of a torque or the resistance to shocks without sliding relative to the arbor, or for applications requiring a large geometric compensation to address variations in the diameter of the arbor, for example.

To this end, a first aspect of the invention relates to a timepiece component intended to be driven onto an arbor along a driving axis, comprising:
a body,
a coupling interface, arranged to cooperate with the arbor,
at least one flexible peripheral portion, arranged between the body and the coupling interface,
N first connecting bridges, linking the flexible peripheral portion with the coupling interface,
second connecting bridges, linking the flexible peripheral portion with the body, in which N is an integer greater than or equal to 2,
characterized in that, in a plane normal to the driving axis, at least one of the N first connecting bridges is offset from at least one of the second connecting bridges by an angle:
comprised between (170/N)° and (190/N)°, for example an angle of (180/N)°, and having the driving axis as a vertex.

According to the implementation above, the timepiece component comprises a flexible peripheral portion, first connecting bridges (arranged between the flexible peripheral portion and the coupling interface), and second connecting bridges (arranged between the flexible peripheral portion and the body of the timepiece component), which allows obtaining an elastic structure shaped so as not to cause deformation of the remainder of the timepiece component, for example of a toothing or of the functional zone of a rocker. Moreover, at least one of the N first connecting bridges is offset from at least one of the second connecting bridges by an angle comprised between (170/N)° and (190/N)°, which allows maximizing the elastic displacement of the coupling interface, to properly compensate for any dimensional variations in the arbor and/or in the coupling interface, while ensuring a clamping force of the coupling interface on the arbor sufficient to prevent any sliding between the arbor and the timepiece component, particularly any sliding during a shock or the transmission of a torque.

The timepiece component may have the following characteristics, taken individually or in combination.

According to one embodiment, the arbor is a full component, movable or non-movable with respect to the frame of the movement. Alternatively, the arbor may be a portion of a timepiece component, movable or non-movable with respect to the frame of the movement. Typically, the arbor comprises at least one cylindrical male part, preferably with a circular section, to receive the timepiece component.

According to one embodiment, N is an integer comprised between 2 and 6, and preferably N = 3. The timepiece component can be compact and have small dimensions while providing the aforementioned advantages: obtaining an elastic structure sufficiently rigid to preferably prevent any sliding on the arbor, and thus transmitting a predefined torque without relative rotational displacement of the component with respect to the arbor, while also being able to compensate for significant dimensional variations. Particularly, the timepiece component can for example be inscribed in a circle with a diameter of less than 6 mm, or 5 mm, or 4 mm.

According to one embodiment, the timepiece component is driven onto the arbor to obtain a mechanical connection of the interlocking type (all degrees of freedom blocked) with the elastic structure sufficiently rigid to preferably prevent any sliding on the arbor. However, an interlocking connection can be provided with a possibility of relative movement (typically sliding) under certain conditions, and the increased rigidity can be used to create a cannon pinion with a precise and low-deformation bore, driven onto an arbor with a reproducible sliding threshold torque.

According to one embodiment, the timepiece component comprises N or more second connecting bridges, and preferably comprises N second connecting bridges. The first connecting bridges and the second connecting bridges are evenly or equally distributed all around the coupling position or interface, which allows keeping good coaxiality of the arbor with the axis defined by the coupling interface.

According to one embodiment, the at least one flexible peripheral portion forms a flexible peripheral cage surrounding, preferably completely, the coupling interface.

According to one embodiment, the at least one flexible peripheral portion comprises at least one flexible peripheral blade arranged between said at least one of the N first connecting bridges and at least one of the second connecting bridges, which are offset or juxtaposed together. The flexible peripheral portion deforms mainly in bending, which allows accommodating larger geometric deviations while remaining compact.

According to one embodiment, the body forms or comprises an anchor portion to which the second connecting bridges are anchored. This anchor portion may be significantly more massive than the flexible peripheral portion. Particularly, an anchor cross-section of the anchor portion is greater than 1.5 times the cross-section of the at least one flexible peripheral blade, preferably greater than 2 times a cross-section of the at least one flexible peripheral blade, preferably greater than 3 times a cross-section of the at least one flexible peripheral blade. By "cross-section", it is meant the area of the surface obtained when the portion or the blade is cut along a radial direction with respect to the driving axis. Particularly, for a given radial direction with respect to the driving axis, the anchor cross-section of the anchor portion may be greater than 1.5 times the cross-section of the at least one flexible peripheral blade, may be preferably greater than 2 times the cross-section of the at least one flexible peripheral blade, may be preferably greater than 3 times the cross-section of the at least one flexible peripheral blade. By convention, "average anchor cross-section" refers to the average of the cross-section of the anchor portion over the extent of the anchor portion around the coupling position or interface, particularly around the driving axis. By convention, "average cross-section of the at least one flexible peripheral blade" refers to the average of the cross section of the at least one flexible peripheral blade over the extent of the at least one flexible peripheral blade around the coupling position or interface, particularly around the driving axis. "Extent of the anchor portion" refers to the extent of the anchor portion around the circumference of the coupling interface that is to say over 360° around the driving axis. "Extent of the at least one flexible portion" refers to the extent of the at least one flexible portion from a first connecting bridge to a second connecting bridge. Particularly, the average anchor cross-section of the anchor portion may be greater than 1.5 times the average cross-section of the at least one flexible peripheral blade, may be preferably greater than 2 times the average cross-section of the at least one flexible peripheral blade, may preferably be greater than 3 times the average cross-section of the at least one flexible peripheral blade.

In other words, the anchor body or portion is dimensioned to be much more rigid than the flexible peripheral portion and/or the flexible peripheral blade. Within the framework of a planar timepiece component driven onto an arbor, the flexible peripheral portion and/or the flexible peripheral blade may deform preferentially in bending due to the displacements caused by the tight mounting on the arbor, and the anchor body or portion may also be subjected to stresses leading to bending load. However, in a cutting plan normal to the plane of the component and passing through the center of the arbor, the moment of inertia of the flexible peripheral portion and/or of the flexible peripheral blade is much lower than the moment of inertia of the anchor body or portion. According to one embodiment, in any cutting plan comprising the driving axis, the moment of inertia of the section of the flexible peripheral portion and/or the section of the flexible peripheral blade is three times lower, preferably eight times lower, preferably fifteen times lower, preferably twenty-five times lower, than the moment of inertia of the section of the body or the section of the anchor portion. Such characteristics guarantee very low or zero deformation of the anchor body or portion, and at the very least negligible compared to the deformations or to the displacements of the flexible peripheral portion and/or of the flexible peripheral blade.

More generally, the body or the remainder of the body of the timepiece component is much more massive or rigid than the flexible peripheral portion and its flexible peripheral blade, and the deformations caused during the assembly with the arbor remain concentrated in the flexible peripheral portion and its flexible peripheral blade. In other words, during the assembly of the timepiece component with the arbor, the deformation of the body or the remainder of the body of the timepiece component is minimized as much as possible, or is zero.

According to one embodiment, the anchor cross-section varies by less than 30%, less than 20%, less than 10% over at least 40%, or over at least 50%, or over at least 60%, or over at least 70%, of the extent of the anchor portion around the coupling position or interface, particularly around the driving axis. According to one embodiment, the flexible peripheral blade cross-section varies by less than 30%, or less than 20%, or less than 10% over at least 40%, or over at least 50%, or over at least 60%, or over at least 70%, of the extent of the at least one flexible peripheral blade.

According to one embodiment, the body comprises at least one flexible anchor blade arranged between at least one of the second connecting bridges and the body or the remainder of the body of the timepiece component. Such flexible blades linking the body or the remainder of the body to at least one (and preferably each) of the second connecting bridges allow further increasing the capability of geometric compensation of the manufacturing variations and/or minimizing the deformation of the body or of the remainder of the body of the timepiece component.

According to one embodiment, the at least one flexible anchor blade has a flexible anchor blade cross-section substantially equal to the flexible peripheral blade cross-section.

According to one embodiment, the coupling interface comprises N coupling portions, each distinct from others and each arranged to cooperate with the arbor, and preferably each arranged facing and/or directly linked to one of the N first connecting bridges. Distinct coupling portions limit the hyperstatism problems and increase the geometric compensation capability that allows addressing the dimensional variations of the components.

According to one embodiment, the coupling interface comprises at least one, and preferably N, flexible coupling blade(s), forming for example lobes (in particular Ω-omega shaped), arranged between the coupling portions. Such structures provide significant deformability, in particular in bending, within a limited overall dimension.

According to one embodiment, the timepiece component comprises a plurality of flexible coupling blades arranged between the coupling portions, and the flexible coupling blades and the coupling portions form a coupling cage intended to surround, preferably completely, the arbor. Such a coupling cage allows limiting the position or centering deviations of the arbor after assembly.

According to one embodiment, said at least one flexible coupling blade has a flexible coupling blade cross-section,
and the flexible coupling blade cross-section is substantially equal to the flexible peripheral blade cross-section.

According to one embodiment, the flexible peripheral blade has an average flexible peripheral blade cross-section (over at least 40% of its length, over at least 50% of its length, over at least 60% of its length, over at least 70% of its length), the flexible coupling blade has an average flexible coupling blade cross-section (over at least 40% of its length, over at least 50%, over at least 60% of its length, over at least 70% of its length), and the average flexible coupling blade cross-section is comprised in a range of values from 0.8 times to 1.2 times the average flexible peripheral blade cross-section.

According to one embodiment:
said at least one flexible coupling blade has a flexible coupling blade cross-section,
said at least one flexible peripheral blade has a flexible peripheral blade cross-section,
and at least part of the flexible coupling blade has a flexible coupling blade cross-section substantially greater than the flexible peripheral blade cross-section, preferably a central part of the flexible coupling blade has a flexible coupling blade cross-section greater than 1.2 times, preferably 1.5 times, preferably 1.8 times, the flexible peripheral blade cross-section. Such an implementation guarantees a high clamping force of the coupling interface on the arbor.

According to one embodiment, the central part of the lobes (in particular Ω-omega shaped) has a flexible coupling blade cross-section greater than 1.2 times, preferably 1.5 times, preferably 1.8 times the flexible peripheral blade cross-section, and the peripheral part(s) of the lobes have a flexible coupling blade cross-section substantially equal to the flexible peripheral blade cross-section. Such an implementation guarantees a high clamping force of the coupling interface on the arbor (the central portion having the flexible coupling blade cross-section greater than 1.2 times, preferably 1.5 times, preferably 1.8 times the flexible peripheral blade cross-section) while providing good deformation capability (the lateral or peripheral portions having the flexible coupling blade cross-section substantially equal to the flexible peripheral blade cross-section).

According to one embodiment, the at least one flexible peripheral portion comprises at least one concave portion directed towards and facing at least one of the first connecting bridges and/or directed towards and facing at least one of the second connecting bridges. This concave shape allows minimizing the displacement of the second connecting bridges. According to one embodiment, said at least one concave portion is arranged on an outer surface of the at least one flexible peripheral portion, directed towards and facing at least one of the first connecting bridges connected to an inner surface of the at least one flexible peripheral portion. According to one embodiment, said at least one concave portion is arranged on an inner surface of the at least one flexible peripheral portion, directed towards and facing at least one of the second connecting bridges connected to an outer surface of the at least one flexible peripheral portion.

According to one embodiment, the timepiece component comprises at least one, and preferably N, third connecting bridge(s) linking the coupling interface and the flexible peripheral portion, arranged in the extension of at least one of the second connecting bridges. Such third connecting bridges allow increasing the rigidity of the timepiece component and in particular of the coupling interface.

According to one embodiment:
the first connecting bridges are linked to the flexible peripheral portion in a first connecting zone inscribed between a first circle of radius R1 and a second circle of radius R2 centered on the driving axis,
the second connecting bridges are linked to the flexible peripheral portion in a second connecting zone inscribed between a third circle of radius R3 and a fourth circle of radius R4 centered on the driving axis,
and R1 < R2 < R3 < R4.

According to one embodiment, the third connecting bridges are linked to the flexible peripheral portion in a third connecting zone inscribed between a fifth circle of radius R5 and a sixth circle of radius R6 centered on the driving axis,
and R1 < R2 < R5 < R6 < R3 < R4.

According to one embodiment:
the coupling interface defines at least one, and preferably N, inner recess(s) arranged between the arbor and the coupling interface, passing through the timepiece component and having an inner recess surface,
the first connecting bridges, the coupling interface and the flexible peripheral portion define at least one, and preferably N, peripheral recess(s) passing through the timepiece component and having a peripheral recess surface,
and the inner recess surface is less than or equal to the peripheral recess surface. According to this implementation, the material allocated to the flexible peripheral portion is limited to ensure good deformability in order to easily compensate for variations in the dimensions of the arbor or of the coupling interface.

According to one alternative embodiment:
the coupling interface defines at least one, and preferably N, inner recess(s) arranged between the arbor and the coupling interface, passing through the timepiece component and having an inner recess surface,
the first connecting bridges, the coupling interface, and the flexible peripheral portion define at least one, and preferably N, peripheral recess(es) passing through the timepiece component and having a peripheral recess surface,
and the inner recess surface is greater than or equal to the peripheral recess surface. According to this implementation, the material allocated to the flexible peripheral portion is maximized to ensure good rigidity in order to guarantee good clamping force of the coupling interface on the arbor.

According to one embodiment, the timepiece component is a toothed wheel comprising n teeth, and preferably n=x.N, where x is an integer greater than or equal to 2. According to this embodiment, the teeth of the toothed wheel and the first connecting bridges are well distributed together.

According to one embodiment, at least one of the first bridges and/or of the second bridges and/or of the third bridges comprises a pair of bridge walls separated by a space. According to this embodiment, at least one of the first bridges and/or of the second bridges and/or of the third bridges comprises two separate and spaced unitary walls or bridges. Rigidity is improved without increasing the mass of the timepiece component. For each first or second or third "doubled" bridge, the two walls or two unitary bridges are essentially parallel or at least oriented along parallel or substantially parallel directions.

According to one embodiment, the timepiece component comprises at least one tooth, and at least one of the second bridges and/or of the third bridges is arranged facing said at least one tooth. According to one embodiment, said at least one tooth comprises a pair of tooth walls separated by a space, and the space extends between the bridge walls of said at least one of the second bridges and/or of the third bridges arranged facing said at least one tooth. The rigidity is improved without increasing the mass of the timepiece component.

According to one embodiment, the timepiece component is a planar component, in particular free of any material protruding from the plane of the timepiece component.

According to one embodiment, the timepiece component is a component formed from, or comprising, or consisting of, at least one of the following materials: silicon, ceramic, and/or nickel, nickel-phosphorus alloy, and/or metal glass.

According to one embodiment, the timepiece component is a rocker or an anchor of an escapement device.

A second aspect of the invention relates to a timepiece assembly (for example a watchmaking piece) comprising an arbor and a timepiece component according to the first aspect driven onto the arbor.

### DESCRIPTION OF THE FIGURES

Other characteristics and advantages of the present invention will become more apparent upon reading the following detailed description of embodiment(s) of the invention given by way of non-limiting example(s) and illustrated by the appended drawings, in which:

FIG. 1 represents a front view of a first variant of a first embodiment of the invention with a timepiece component forming a rocker and comprising a body, a coupling interface, a flexible peripheral portion, first connecting bridges arranged between the coupling interface and the flexible peripheral portion, and second connecting bridges arranged between the flexible peripheral portion and the body;

FIG. 2 represents a first detailed view of the timepiece component of FIG. 1;

FIG. 3 represents a second detailed view of the timepiece component of FIG. 1;

FIG. 4 represents a front view of a second variant of the first embodiment of the invention with a timepiece component forming a toothed wheel (here an escapement wheel) and similar to the first variant of the embodiment of FIG. 1 with regard to the coupling interface, the flexible peripheral portion, the first connecting bridges arranged between the coupling interface and the flexible peripheral portion, and the second connecting bridges arranged between the flexible peripheral portion and the body;

FIG. 5 represents a first detailed view of the timepiece component of FIG. 4;

FIG. 6 represents a second detailed view of the timepiece component of FIG. 4;

FIG. 7 represents a front view of a first variant of a second embodiment of the invention with a timepiece component forming a toothed wheel of a gear train and which differs from the first embodiment of FIGS. 1 to 6, in particular with regard to the coupling interface;

FIG. 8 represents a first detailed view of the timepiece component of FIG. 7;

FIG. 9 represents a second detailed view of the timepiece component of FIG. 7;

FIG. 10 represents a front view of a second variant of the second embodiment of the invention with a timepiece component forming a toothed wheel of a gear train and which differs from the first variant of FIG. 7 in particular at the level of third connecting bridges provided between the flexible peripheral portion and the coupling interface;

FIG. 11 represents a first detailed view of the timepiece component of FIG. 10;

FIG. 12 represents a second detailed view of the timepiece component of FIG. 10;

FIG. 13 represents another example of a timepiece component according to the second variant of the second embodiment;

FIG. 14 represents another example of a timepiece component according to the second variant of the second embodiment, similar to the example of FIG. 13.

### DETAILED DESCRIPTION OF EMBODIMENT(S)

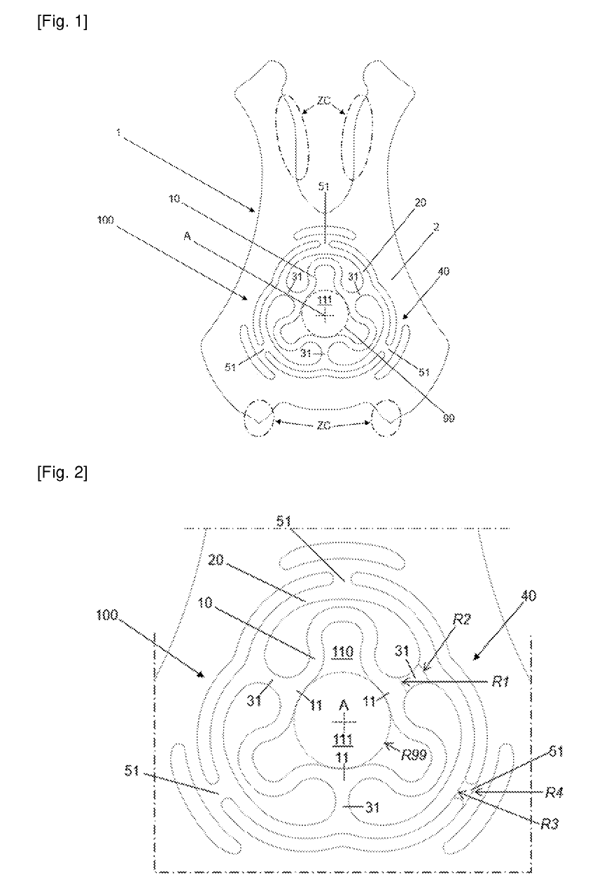

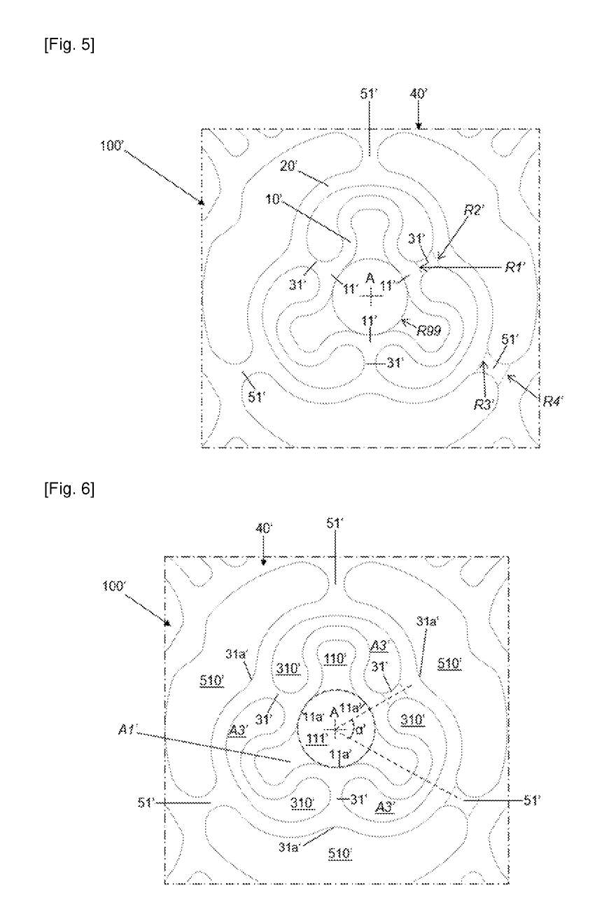

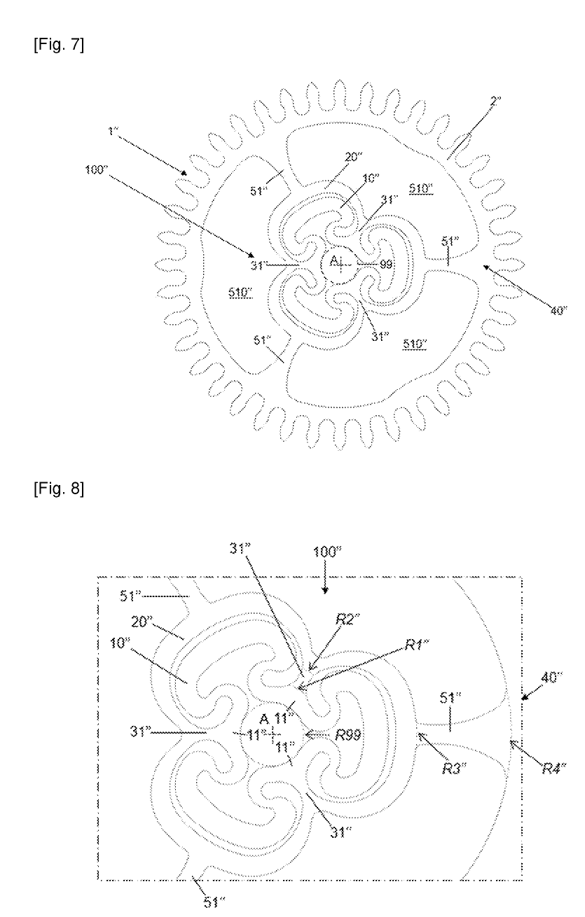

Two embodiments, each having a first variant and a second variant, are described below. The numeric references are identical for the identical or similar structures between the variants and the embodiments. The first variant of the first embodiment is described in FIGS. 1 to 3, which bear only numeric references, without symbols (“'”, “"”, “*”, “**”). The second variant of the first embodiment is described in FIGS. 4 to 6, which bear numeric references followed by the symbol “'”. The first variant of the second embodiment is described in FIGS. 7 to 9, which bear numeric references followed by the symbol “"”. The second variant of the second embodiment is described in FIGS. 10 to 12, which bear numeric references followed by the symbol “*”. The example of FIG. 14 bears numeric references followed by the symbol “**”. In the text below, the numerical references are devoid of the symbols “'”, “"”, “*”, “**” (visible on the different figures) in order to facilitate their description.

FIG. 1 represents a front view of a first variant of a first embodiment of the invention with a timepiece component 1, forming in this example a rocker or an anchor or a blocking mobile element for an escapement, intended to be driven onto an arbor 99 (in dotted lines) along a driving axis, and comprising:
a body 2,
an elastic structure 100 with in particular:
a coupling interface 10, arranged to cooperate with the arbor 99,
a flexible peripheral portion 20, arranged between the body 2 and the coupling interface 10,
N (three in this example) first connecting bridges 31, linking the flexible peripheral portion 20 with the coupling interface 10,
second connecting bridges 51 (three in this example), linking the flexible peripheral portion 20 with the body 2,
a base 40 linking each second connecting bridge 51 with the remainder of the body 2.

In detail, the elastic structure 100 for the timepiece component has the particularity of comprising, firstly:
the first closed-loop coupling interface 10, defining a central aperture 110 with geometric axis A, intended to receive the arbor 99,
the closed-loop flexible peripheral portion 20, intended to support the coupling interface 10 by means of the first connecting bridges 31 extending radially or substantially radially with respect to the axis A.
the base 40, intended to support the flexible peripheral portion 20 and link it to the remainder of the body 2 of the timepiece component 1 by means of the second connecting bridges 51 extending radially or substantially radially with respect to the axis A.

The timepiece component of FIG. 1 is here a rocker of an escapement device with cooperation zones ZC intended to cooperate with the other components of an escapement device, such as for example one or more escapement wheels and an impulse pin. It is important to note that the position of these cooperation zones ZC with respect to the position of the axis A determines the proper functioning of the escapement that integrates the timepiece component of FIG. 1.

As shown in FIG. 2, the first connecting bridges 31 are inscribed between a first circle of radius R1 and a second circle of radius R2, and the second connecting bridges 51 are inscribed between a third circle of radius R3 and a fourth circle of radius R4, with R1<R2<R3<R4.

Combining the coupling interface 10 and the flexible peripheral portion 20 and linking them to each other and also to the remainder of the timepiece component 1 by means of first and second connecting bridges 31 and 51 respectively, allows obtaining an elastic structure shaped so as not to cause deformation of the remainder of the timepiece component 1. When the shape of the timepiece component 1 allows it, the base 40 can also be shaped to modulate the rigidity of the assembly formed by the coupling interface 10 and the flexible peripheral portion 20.

Preferably, the first connecting bridges 31 are all identical and the second connecting bridges 51 are all identical.

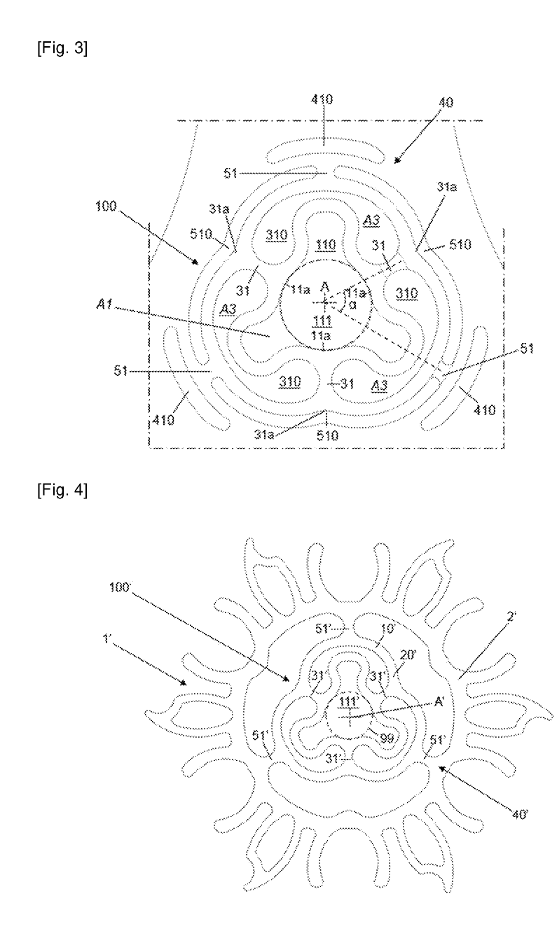

Preferably, the first and second connecting bridges 31 and 51 respectively, are equally distributed around the axis A. Preferably, the elastic structure 100 comprises a symmetry of revolution of order N around the axis A, the first and second connecting bridges 31 and 51 respectively, being angularly offset by an angle α = (180/N)° visible in FIG. 3.

The first and second connecting bridges 31 and 51 respectively, are thus juxtaposed and extend radially between different radii of the elastic structure 100.

As shown in FIG. 3, the first connecting bridges 31 define first apertures 310 distributed around the axis A, and preferably equally distributed around the axis A. The second connecting bridges 51 define second apertures 510 distributed around the axis A, and preferably equally distributed around the axis A.

Preferably, the first apertures 310 are all identical and the second apertures 510 are all identical.

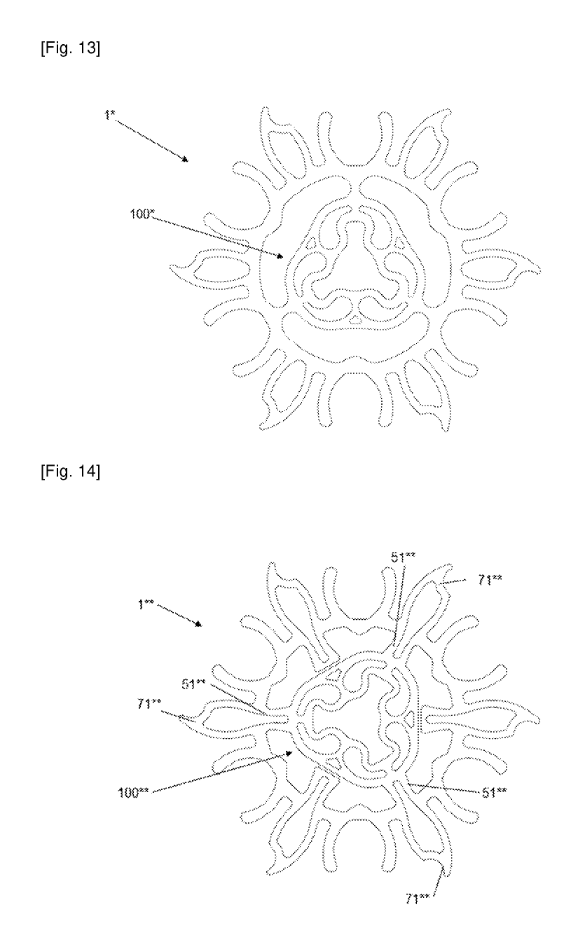

Preferably, N=3 for timepiece components 1 of a watch movement, and particularly for components of an escapement. Such a condition allows maximizing the extent of the deformed material of the elastic structure 100 and maximizing the format of the radii of curvature of the coupling interface 10 and/or of the flexible peripheral portion 20, while providing sufficient space to allow a timepiece-dimensioned arbor (whose diameter is typically comprised between 0.15 mm and 0.5 mm) to pass through the central aperture 110. Moreover, such a condition allows confining the elastic structure 100 to the center of the timepiece component 1, without it extending over the entire body 2 of the component. Finally, such a condition is particularly aesthetically pleasing and symmetrical for a wheel whose number n of teeth is a multiple of 3 (as illustrated in particular in FIGS. 4 and 13, with wheels comprising 6 first teeth and 12 second teeth).

Preferably, n=x.N, where x is an integer greater than or equal to 2.

The two embodiments, each having a first variant and a second variant, are described with the particular condition N = 3 and α = 60°, but other configurations can be envisaged (N = 2, N = 4 or more).

The two embodiments differ by criteria of areas or surfaces in particular between the coupling interface 10 and the flexible peripheral portion 20, which allow highlighting the fact that in a first embodiment the quantity of material at the level of the coupling interface 10 is not necessarily maximized, while it is in the second embodiment.

The first embodiment (first variant FIGS. 1 to 3 and second variant FIGS. 4 to 6) is distinguished in particular by a coupling interface 10 whose central aperture 110 with axis A has an area A1 less than or equal to N times the area A3 of each of the first apertures 310, as will be described below.

The central aperture 110 here has a triangular or trilobed shape (each lobe being in particular Ω-omega shaped), whose walls are defined by the coupling interface 10. This coupling interface 10 comprises elements 11 (or coupling portions 11) for receiving an arbor 99. Each of the receiving elements 11 is disposed in line with a first connecting bridge 31.

Each of the receiving elements 11 is shaped to come into contact with an arbor 99, preferably in the form of a cylinder, particularly a right cylinder, intended to be inscribed within a central aperture 111, located within the aperture 110 itself and at least partially delimited by these same receiving elements 11.

Particularly, each of the receiving elements 11 comprises a receiving surface 11a which is preferably concave when viewed from the axis A, so as to optimally fit the cylindrical arbor 99 and thus limit the contact pressures as soon as the driving of the arbor 99 is initiated. Thus, the receiving elements 11 are shaped (counter-shaped to the arbor 99) to minimize the stresses and distribute them optimally in order to prevent any breakage of the timepiece component 1 during the driving onto its arbor 99.

In other words, since the first connecting bridges 31 are located in line with the receiving elements 11, these first connecting bridges 31 each have a concave end that opens out into the central aperture 111. The opposite end 31a of each of the connecting bridges 31 also has a concave shape that opens out into each of the second apertures 510. This concave shape makes the coupling interface 10 more flexible while minimizing, as much as possible, the deformation of the second connecting bridges 51.

The coupling interface 10 is therefore maintained on the flexible peripheral portion 20 by means of first connecting bridges 31, this flexible peripheral portion 20 being itself maintained on the base 40 of the body 2 of the timepiece component 1 by means of second connecting bridges 51. Such an arrangement allows minimizing the stiffness of these elastic portions and maximizing the deformed material for a given overall dimension, without impacting the geometric integrity of the remainder of the body 2 of the timepiece component 1. Indeed, during the driving of the arbor 99, the micron-range displacements of the first connecting bridges 31 are directed in directions opposite to those of the displacements of the second connecting bridges 51, thus preserving the geometric integrity of the remainder of the timepiece component 1.

Such an arrangement of the coupling interface 10 and of the flexible peripheral portion 20, and of the base 40, therefore allows minimizing the stresses within the elastic structure 100 for a given clamping force of the arbor 99.

In view of the expected holding force of the timepiece component 1 (the rocker in FIGS. 1-3 or the wheel in FIGS. 4-6) on its arbor 99, it is not necessary to maximize the perimeter of the coupling interface 10, so that the extent of the aperture 110 is of the same order as, or less than, the sum of all the extents of the apertures 310. In other words, the central aperture 110 with axis A has an area A1 less than or equal to N times the area A3 of each of the first apertures. For the two variants of the first embodiment, A1~0.15 mm² and A3~0.05 mm².

Particularly, it can be noted that in the first embodiment (first variant represented in FIGS. 1 to 3 and second variant represented in FIGS. 4 to 6):
the coupling interface 10 forms a flexible coupling cage with flexible coupling blades having convolutions,
the flexible peripheral portion 20 forms a flexible peripheral cage with flexible peripheral blades having convolutions,
and the flexible coupling blades have substantially the same cross-section as that of the flexible peripheral blades.

In the first variant of the first embodiment, represented in FIGS. 1 to 3, the minimization of the stresses is all the more important thanks to one particular conformation of the base 40, which has the particularity of comprising apertures, particularly N apertures 410, in particular disposed in line with the second connecting bridges 51. Preferably, these apertures 410 are equally distributed around the axis A, and extend tangentially with respect to the axis A. The angular extent of these apertures is preferably less than the angle α (of the order of 40° or 45° in the particular example of FIGS. 1 to 3). Flexible anchor blades linking each of the second connecting bridges 51 to the body 2 or to the remainder of the body 2 are thus provided.

In the example of FIGS. 1 to 3, the body 2 or the remainder of the body 2 extends beyond the apertures 410 (radially or laterally) and has a shape that gives it a rigidity much greater than the rigidity of the flexible peripheral portion 20. Particularly, in any cutting plan comprising the axis A, a section of the body 2 or of the remainder of the body 2 has a moment of inertia significantly greater than the moment of inertia of a section of the flexible peripheral portion 20. Consequently, even if the driving is performed on an arbor 99 at the maximum of its diameter tolerance, the flexible peripheral portion 20 will deform, but the body 2 or the remainder of the body 2 will not deform, or hardly at all, so that the position of the cooperation zones ZC with respect to the axis A will not be affected by a mounting on an arbor 99 at the maximum of its diameter tolerance.

In the second variant of the first embodiment, represented in FIGS. 4 to 6, the base 40 corresponds to the felloe of the wheel formed by the timepiece component 1. The stresses within the elastic structure 100 are entirely acceptable for the expected holding force. The base 40 can thus be in the form of a rigid component body element or portion.

In the second embodiment, each vertex (or central part of the Ω-omega) of the coupling interface 10 is bulged in the corresponding first aperture 310, so as to maximize the deformed material within a given overall dimension and thus further optimally distribute the stresses. Thus, the central aperture 110 with axis A has an area A1 greater than or equal to N times the area A3 of each of the first apertures, as will be described below.

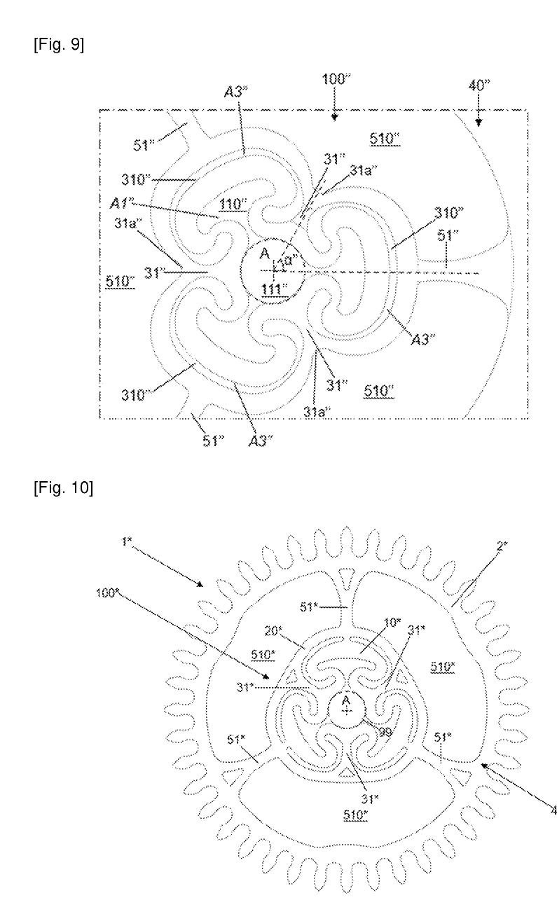

Particularly, and as will be detailed below, in the second embodiment (first variant represented in FIGS. 7 to 9 and second variant represented in FIGS. 9 to 12):
the coupling interface 10 forms a flexible coupling cage with flexible coupling blades having convolutions,
the flexible peripheral portion 20 forms a flexible peripheral cage with flexible peripheral blades having convolutions,
and the flexible coupling blades have substantially, in particular at each vertex (or central part of the Ω-omega), a cross-section greater than that of the flexible peripheral blades, and particularly a flexible coupling blade cross-section greater than 1.5 times the flexible peripheral blade cross-section.

In the first variant represented in FIGS. 7 to 9, it can be noted that A1~0.3 mm² and A3~0.07 mm². Apart from the fact that A1 ≥ 3.A3, the elastic structure 100 of the timepiece component 1 in FIGS. 7 to 9 is comparable to that of the second variant of the first embodiment in FIGS. 4 to 6. Here too, the base 40 corresponds to the felloe of the wheel. It is noted that the portions 31a are particularly bulged in order to minimize, as much as possible, the deformation of the second connecting bridges 51. However, these bulges cannot be too pronounced due to the risk of inducing excessive stresses at these points.

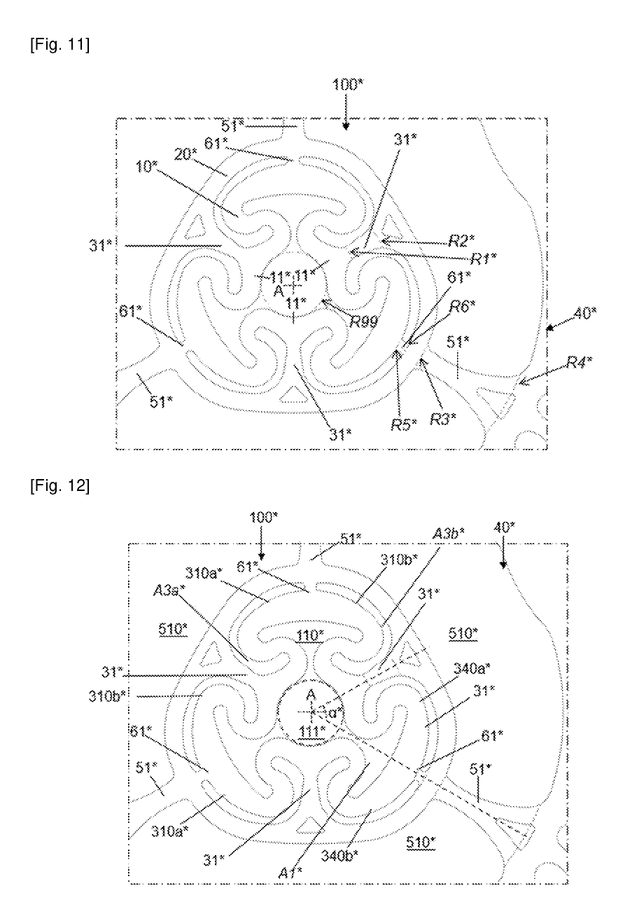

In the second variant represented in FIGS. 10 to 12, it can be noted that in order to further reduce the stresses while minimizing the deformation of the second connecting bridges 51, it can be proposed to retain the coupling interface 10 to the flexible peripheral portion 20 by third connecting bridges 61 disposed radially with respect to the axis A, which complement the first connecting bridges 31. These third connecting bridges 61 are preferably located in line with the second connecting bridges 51, between two consecutive first connecting bridges 31, and extend between two circles of radii R5 and R6 respectively (FIG. 11). In this second variant, R1<R2<R5<R6<R3<R4. These third connecting bridges 61 ideally replace the concave portions 31a of the first embodiment and of the first variant of the second embodiment to minimize the stresses at the level of the zones where the concave portions were located, while minimizing as much as possible the deformation of the second connecting bridges.

FIG. 13 represents a timepiece component 1 forming an escapement wheel, and having the same elastic structure 100 as that of the timepiece component 1 of FIG. 10.

FIG. 14 represents a timepiece component 1 forming an escapement wheel, and differing from the previous examples in that the second bridges 51 are doubled or each include a pair of second-bridge walls. Each second bridge 51 is facing an escapement tooth 71. As can be noted in FIG. 14, a space separates the second-bridge walls, and this space is remarkable in that it extends or continues within each escapement tooth 71. In other words, each second-bridge wall extends or is facing an escapement tooth wall, which contributes to providing good rigidity to the assembly, with a reduced mass made possible by the space that separates the second-bridge walls and the escapement tooth walls.

The timepiece component 1 and/or the elastic structure 100 is advantageously made from a micromachinable material, in particular a silicon-based material, that is to say comprising at least 50% micromachinable material by weight. Particularly, the component and/or the structure may comprise (or consist of) in whole or in part:
monocrystalline silicon, regardless of its orientation,
polycrystalline silicon,
amorphous silicon,
amorphous silicon dioxide,
doped silicon, regardless of the type and level of doping, or
porous silicon.

The timepiece component 1 may also comprise in whole or in part:
silicon carbide,
glass,
ceramic,
diamond,
nickel,
a nickel-phosphorus alloy, or
quartz.

### Industrial application

A timepiece component according to the present invention, and its manufacture, are capable of industrial application.

It will be understood that various modifications and/or improvements obvious to the person skilled in the art can be made to the different embodiments of the invention described in the present description without departing from the framework of the invention.

Particularly, in the embodiments and variants described, the first connecting bridges 31 are all identical and/or equally distributed around the mounting axis A, but at least one of the first connecting bridges 31 may be intended to be different from the others and/or not equally distributed around the mounting axis A. Similarly, in the embodiments and variants described, the second connecting bridges 51 are all identical and/or equally distributed around the driving axis A, but at least one of the second connecting bridges 51 may be intended to be different from the others and/or not equally distributed around the driving axis A. The timepiece component 1 is not necessarily a component of the escapement or of the oscillator and may be a pawl, a rocker, a toothed wheel, or any kind of component permanently driven onto an arbor. Alternatively, the timepiece component can be adjusted onto an arbor, the coupling interface and/or the flexible peripheral portion being in particular dimensioned to allow a relative rotational displacement of the component with respect to the arbor beyond a given torque value. Such an alternative embodiment would allow the implementation of a torque limiter. Such a limiter could for example be used to make a friction system that is part of a time-setting mechanism for a timepiece movement.

It can also be intended that the first bridges and/or the second bridges and/or the third bridges can each include several parallel or substantially parallel or juxtaposed legs or feet or junctions or portions. In other words, the first bridges and/or the second bridges and/or the third bridges can be inscribed in pairs of first bridges and/or second bridges and/or third bridges.

1. A timepiece component intended to be driven onto an arbor along a driving axis, comprising:
a body,
a coupling interface, arranged to cooperate with the arbor,
at least one flexible peripheral portion, arranged between the body and the coupling interface,
N first connecting bridges, linking the flexible peripheral portion with the coupling interface,
second connecting bridges, linking the flexible peripheral portion with the body,
wherein N is an integer greater than or equal to 2,
characterized in that, in a plane normal to the driving axis, at least one of the N first connecting bridges is offset from at least one of the second connecting bridges by an angle:
comprised between (170/N)° and (190/N)°, for example an angle of (180/N)°, and
having the driving axis as a vertex.

2. The timepiece component according to claim 1, wherein N is an integer comprised between 2 and 6, and preferably N = 3.

3. The timepiece component according to claim 1, comprising N or more second connecting bridges, and preferably comprising N second connecting bridges.

4. The timepiece component according to claim 1, wherein the at least one flexible peripheral portion forms a flexible peripheral cage surrounding, preferably completely, the coupling interface.

5. The timepiece component according to claim 1, wherein the at least one flexible peripheral portion comprises at least one flexible peripheral blade arranged between said at least one of the N first connecting bridges and the at least one of the second connecting bridges juxtaposed together.

6. The timepiece component according to claim 5, wherein the body comprises an anchor portion to which the second connecting bridges are anchored, the anchor portion having an anchor cross-section, the at least one flexible peripheral blade having a flexible peripheral blade cross-section, and wherein the anchor cross-section is greater than 1.5 times the flexible peripheral blade cross-section, preferably greater than 2 times the flexible peripheral blade cross-section, preferably greater than 3 times the flexible peripheral blade cross-section.

7. The timepiece component according to claim 1, wherein the body comprises at least one flexible anchor blade arranged between at least one of the second connecting bridges and the remainder of the body.

8. The timepiece component according to claim 6, wherein the at least one flexible anchor blade has a flexible anchor blade cross-section substantially equal to the flexible peripheral blade cross-section.

9. The timepiece component according to claim 1, wherein the coupling interface comprises N coupling portions, distinct and each arranged to cooperate with the arbor, and preferably each arranged facing and/or directly linked to one of the N first connecting bridges.

10. The timepiece component according to claim 9, wherein the coupling interface comprises at least one, and preferably N, flexible coupling blade(s), for example lobes or Ω (Omega) arranged between the coupling portions.

11. The timepiece component according to claim 10, comprising a plurality of flexible coupling blades arranged between the coupling portions, wherein the flexible coupling blades and the coupling portions form a coupling cage intended to surround, preferably completely, the arbor.

12. The timepiece component according to claim 6, wherein at least one flexible coupling blade has a flexible coupling blade cross-section,
and wherein a flexible coupling blade cross-section of the at least one flexible coupling blade is substantially equal to the flexible peripheral blade cross-section.

13. The timepiece component according to claim 6, wherein:
at least one flexible coupling blade has a flexible coupling blade cross-section,
said at least one flexible peripheral blade has the flexible peripheral blade cross-section,
and wherein the flexible coupling blade cross-section is substantially greater than the flexible peripheral blade cross-section, wherein a central part of the flexible coupling blade has the flexible coupling blade cross-section greater than 1.5 times the flexible peripheral blade cross-section.

14. The timepiece component according to claim 1, wherein the at least one flexible peripheral portion comprises at least one concave portion directed towards and facing at least one of the first connecting bridges and/or directed towards and facing at least one of the second connecting bridges.

15. The timepiece component according to claim 1, comprising at least one, and preferably N, third connecting bridge(s) linking the coupling interface and the flexible peripheral portion, arranged in the extension of at least one of the second connecting bridges.

16. The timepiece component according to claim 1, wherein:
the first connecting bridges are linked to the flexible peripheral portion in a first connecting zone inscribed between a first circle of radius R1 and a second circle of radius R2 centered on the driving axis,
the second connecting bridges are linked to the flexible peripheral portion in a second connecting zone inscribed between a third circle of radius R3 and a fourth circle of radius R4 centered on the driving axis,
and R1 < R2 < R3 < R4.

17. The timepiece component according to claim 15, wherein the third connecting bridges are linked to the flexible peripheral portion in a third connecting zone inscribed between a fifth circle of radius R5 and a sixth circle of radius R6 centered on the driving axis,
and R1 < R2 < R5 < R6 < R3 < R4.
